(19) United States
(12) Patent Application Publication
(10) Pub. No.: US 2025/0289703 A1
(43) Pub. Date: Sep. 18, 2025

(54) BAR GUN

(71) Applicant: Taprite Micro Matic, Inc., San Antonio, TX (US)

(72) Inventor: Gilbert YANES, Boerne, TX (US)

(21) Appl. No.: 19/083,278

(22) Filed: Mar. 18, 2025

Related U.S. Application Data
(60) Provisional application No. 63/566,653, filed on Mar. 18, 2024.

(51) Int. Cl. B67D 1/00

(52) U.S. Cl. CPC B67D 1/0084; B67D 2001/0094; B67D 2210/00049

(57) ABSTRACT

An improved beverage dispensing apparatus, namely, a beverage dispensing device, comprising a monolithic handle having a plurality of fluid inlet ports and a plurality of fluid outlet ports; a plurality of valves situated within the handle, each valve movable in response to actuation; a plurality of internal fluid channels integrally formed within the monolithic handle, each internal fluid channel possessing smooth walls without irregularities; wherein a first internal fluid channel of the plurality of internal fluid channels fluidly couples a first fluid inlet port of the plurality of fluid inlet ports to a first valve of the plurality of valves; and wherein a second internal fluid channel of the plurality of internal fluid channels fluidly couples the first valve to a first fluid outlet port of the plurality of fluid outlet ports.

### CROSS-REFERENCE TO RELATED APPLICATIONS

This application claims the benefit of U.S. Provisional Application No. 63/566,653, filed Mar. 18, 2024, which is incorporated by reference herein in its entirety. This disclosure relates to U.S. Publication No. 2023/0331533 A1, published Oct. 19, 2023, which is incorporated herein by reference.

### TECHNICAL FIELD

This specification relates to the field of beverage dispensing apparatuses. More specifically, this application is directed toward an improved bar gun having smooth, regular internal fluid channels within a handle and methods of creating the same.

### BACKGROUND

Various systems exist to dispense beverages in retail establishments, bars, or restaurants. Included among these are what are termed in the industry various bar-gun apparatuses. These systems dispense a beverage by transporting it from a storage location where it may be under pressure, to a flow control manifold rigidly attached to a bar or countertop, into a flexible tubing system to a dispenser apparatus or assembly, which may be called a bar gun. A user may actuate a control, for example a depressible button, on the bar gun to dispense one or more beverages or fluids into a container for consumption.

Bar-gun apparatuses are well-known in the art, including those using a bar gun handle constructed of laminated acrylic sheets or plates. For example, U.S. Publication No. 2012/0325855 A1, published Dec. 27, 2012, which is incorporated herein by reference, discloses exemplary bar gun apparatuses comprised of a handle made of laminated acrylic sheets. Each individual sheet or plate may be machined using a laser cutter or similar cutting equipment to form a complex pattern of holes, grooves, and other openings in the sheet. The machined sheets are assembled and bonded together to create a bar gun handle having internal fluid channels formed from the various holes, grooves, and other openings. Additional components are usually attached to the bar gun handle to form the bar gun.

However, conventional bar gun handle construction using laminated acrylic sheets suffers from well-known difficulties, shortcomings, and problems.

First, it takes significant time and effort to fabricate bar gun handles using laminated acrylic. Typically, conventional bar gun handles are made of multiple acrylic layers (five layers, for example), with each layer formed from an acrylic sheet. The acrylic sheets will first receive hours of heat treatment. Next each sheet must be machined, which is a very time-consuming process, with multiple CNC machines operating in both the vertical and horizonal planes, needed to produce the complex pattern of holes, grooves, and other openings. That is followed by assembly and bonding, generally using solvent welding, which can require 12-24 hours of oven curing. After curing is completed, additional CNC machining is required to remove excess bonding solvent and create the perimeter profile of the bar gun handle. Lastly, the bar gun handle is then tumbled to remove tool marks and smooth the exterior.

Second, the solvent welding process used to create multi-layered bar gun handles is costly, imperfect, and requires highly skilled labor. Each acrylic plate contains an intricate pattern of holes, grooves, and other openings. With the solvent welding process, it is difficult to ensure there is full bonding, with no leakage paths between the fluid channels, throughout the bar gun handle. Proper bonding necessitates skilled operators, who apply expensive solvent and careful techniques to increase the probability of full bonding. Even then, the bonded layers can sometimes delaminate, resulting in undesirable cross-linked fluid channels.

Third, the material properties-including acrylic's transparency-presents quality control challenges. Visual inspection of components made from acrylic can be difficult and even subjective. A sizable portion of defective bar gun handles may be missed, further processed through production, and not discovered until final assembly, testing, or inspection, resulting in a substantial waste of time and materials.

Fourth, even if the manufacturing process produces a laminated acrylic bar gun handle without defects, because of limitations inherent in the acrylic sheet machining process, bar gun handles assembled from layered acrylic sheets will contain fluid channels with angled and irregular walls, most commonly when the channels change direction. When a bar gun having such a conventional handle is used to dispense carbonated beverages, the angles and irregular walls disrupt fluid flow and can agitate the carbonated beverages, producing excessive foaming and carbonation breakout.

Therefore, both the process of manufacturing conventional bar gun handles from laminated acrylic sheets and the resulting handles themselves possess recognized difficulties, shortcomings, and problems.

### SUMMARY OF THE PRESENT DISCLOSURE

The present disclosure describes an improved beverage dispensing apparatus, namely, a bar gun with a handle having smooth, regular internal fluid channels, and methods of creating the same. The novel bar gun apparatus and methods in this disclosure provide a bar gun with improved fluid flow and quality of dispensed beverages, including carbonated beverages, and reduced probability of cross-channel leakage, which can be manufactured more quickly, easily, and at less expense than the conventional laminated acrylic construction process.

### BRIEF DESCRIPTION OF THE DRAWINGS

FIG. 1 is perspective view of a bar gun handle.

FIG. 2 is a cross-sectional perspective view of the left side of a conventional bar gun handle.

FIG. 3 is a cross-sectional perspective view of the left side of a bar gun handle in accordance with the present disclosure.

FIG. 4 is a cross-sectional perspective view of the right side of a bar gun handle in accordance with the present disclosure.

### DETAILED DESCRIPTION

An exemplary embodiment of an improved bar gun having a handle with smooth, regular internal fluid channels and methods of creating the same will now be described with more particular reference to the attached figures. Hereafter, details are set forth by way of example to facilitate discussion of the disclosed subject matter. It should be apparent to a person of ordinary skill in the art, however, that the disclosed embodiments are exemplary and not exhaustive of all possible embodiments.

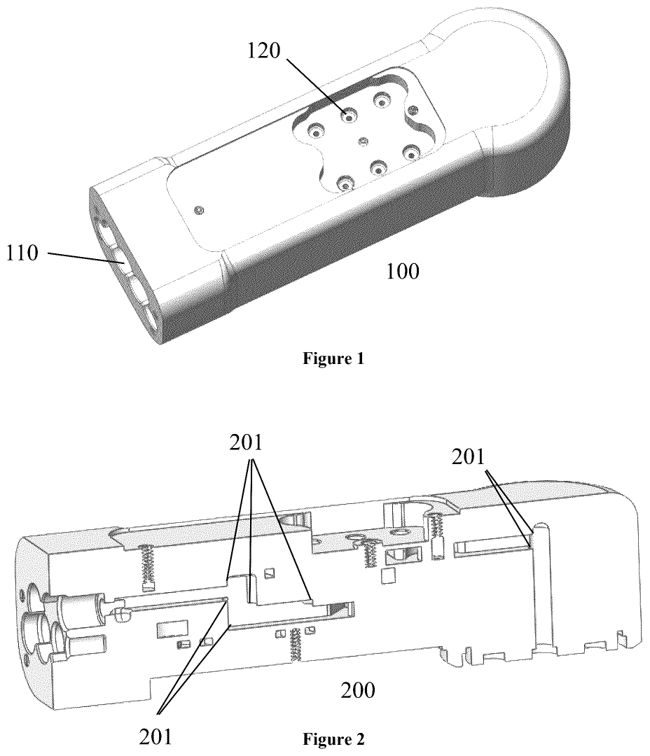

FIG. 1 shows a perspective view of a bar gun handle 100. The bar gun handle 100 comprises one or more inlet ports 110 adapted to receive a flexible tubing system (not shown), which in turn attaches to a flow control manifold (not shown). As illustrated, bar gun handle 100 is designed as a six-valve bar gun. For each valve, the bar gun handle 100 may include one or more value chambers 120 used in forming the valve. The plurality of value chambers 120 may accommodate conventional valve components (not shown), including but not limited to valve bodies and stems, seals such as O-rings, and springs. Additional components (not shown) may be attached to the bar gun handle 100 as well, including but not limited to screws, retaining clips, plates (e.g., butterfly actuation plates), buttons, diffusers, and nozzles.

A bar gun handle may be conventionally constructed using layers of bonded acrylic sheets or plates. FIG. 2 shows a bar gun handle 200 that has been constructed in the conventional manner. The walls of the internal fluid channels of bar gun handle 200 have multiple angled turns, discontinuities, and other irregularities 201. These irregularities 201 may arise from the cross-sectional shape of the channels (for example, square-shaped or rectangular-shaped internal fluid channels with non-smooth corners) as well as from the path of the channels in the bar gun handle (for example, sharp turns of the channels can create discontinuities). FIG. 2 illustrates several examples of the irregularities 201. These interfere with the fluid flow path in bar gun handle 200, preventing laminar flow and creating areas of turbulence. The areas of turbulent flow created by irregularities 201 cause agitation, mixing, and irregular fluctuations in the fluid. For carbonated fluids, the turbulent flow resulting from irregularities 201 can cause excessive foaming and carbonation breakout.

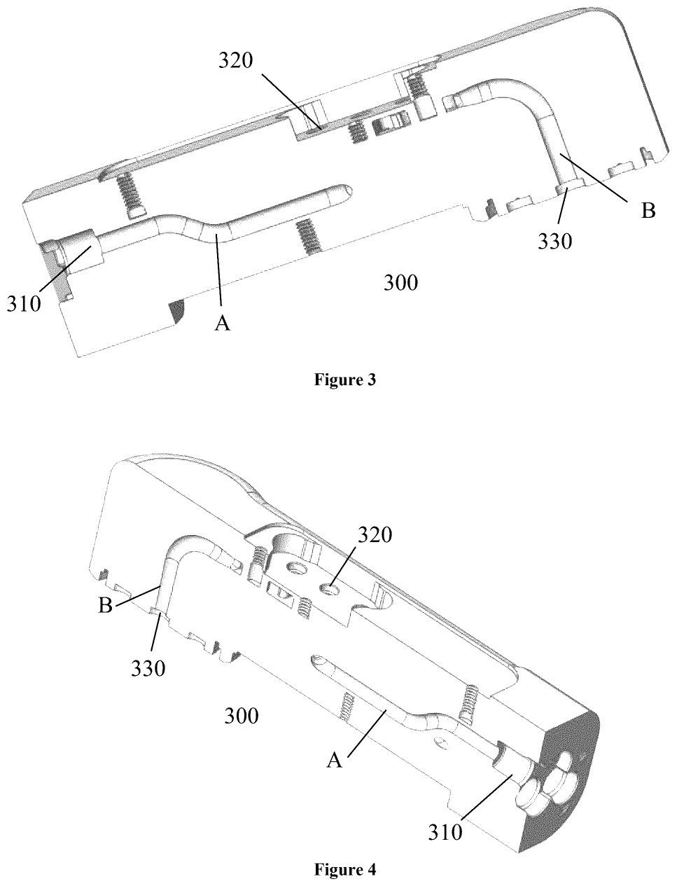

FIGS. 3 and 4 show an exemplary embodiment of an improved bar gun handle in accordance with the present disclosure. FIGS. 3 and 4 show the left and right sides, respectively, of a bar gun handle 300. Within bar gun handle 300 are one or more internal fluid channels possessing smooth, regular walls. The walls of these internal fluid channels do not meet at angles or possess discontinuities, but instead provide a smooth, regular surface that promotes laminar flow of the fluid, with smooth circular or oval cross-sections. Directional changes for such smooth internal fluid channels are provided by curved turns. As illustrated, the bar gun handle 300 may also include one or more inlet ports 310 adapted to receive a flexible tubing system, one or more outlet ports 330 to dispense fluids, and one or more value chambers 320 to accommodate conventional components of a valve.

The bar gun handle 300 in FIGS. 3 and 4 illustrates two exemplary internal fluid channels, A and B, which possess smooth, regular walls, that is, without angles or other discontinuities in the fluid channel walls. Internal fluid channel A is part of a pre-valve channel that runs from an opening into one of the inlet ports 310 to an opening into one of the value chambers 320. Internal fluid channel B is part of a post-valve channel that runs from an opening into one of the value chambers 320 to an opening into one of the outlet ports 330. In other embodiments, a smooth, regular fluid channel may run from an opening into an inlet port to an intersection with one or more other fluid channels or to an internal mixing chamber in the bar gun handle. Similarly, a smooth, regular fluid channel may run from an intersection of two or more fluid channels or an internal mixing chamber in the bar gun handle to an opening into an outlet port. As illustrated, the internal fluid channels A and B include directional changes with smooth, curved turns. Internal fluid channel A, for example, includes two directional changes of approximately 30 degrees each. Internal fluid channel B includes a directional change of approximately 90 degrees. Other turn angles may be used, such as 45 degrees, 60 degrees, or otherwise, as appropriate.

Bar gun handle 300 may have all or substantially all of its internal fluid channels formed as smooth, regular fluid channels in accordance with this disclosure. However, in some embodiments of an improved bar gun handle, only part of the internal fluid channels may be formed as smooth, regular fluid channels, while other internal fluid channels contain angles or other discontinuities. Constructing all or even part of the internal fluid channels of a bar gun handle in accordance with this disclosure may reduce turbulence of the fluids, including but not limited to carbonated water, thereby decreasing the breakout of carbonation and providing higher volume levels.

The bar gun handle 300 may be formed as a single, monolithic piece with internal fluid channels possessing smooth, regular walls integrally formed therein. Three-dimensional (3D) manufacturing, 3D printing, and similar additive manufacturing processes provide one technique for constructing a monolithic bar gun handle having one or more internal fluid channels possessing smooth, regular walls, such as bar gun handle 300. For example, selective laser sintering is an additive manufacturing technique that may be used to construct a bar gun handle 300 as a monolithic component. Selective laser sintering can sinter or fuse materials, such as high-performance powder, into a single, solid bar gun handle 300. Exemplary sintering materials may include medical grade nylon powder. After the monolithic bar gun handle 300 is formed, any excess powder may be blown out from the internal fluid channels. This blow-out process is facilitated by the internal fluid channels' smooth, regular walls formed in accordance with this disclosure.

Depending on the process and materials used to manufacture the monolithic bar gun handle, one or more additional post-processing steps may be applied to prepare a finished product. For example, vapor smoothing may be employed to further finish the internal fluid channels and provide smooth, regular walls to enhance the flow path and seal for liquid use. Other techniques, such as abrasive blasting or tumbling, may also be applied.

In addition to the improved fluid flow and dispensed beverages arising from internal fluid channels having smooth, regular walls, when constructed as a single, monolithic piece, bar gun handle 300 also provides much greater structural strength than using conventional bonded acrylic layers. And, the monolithic construction eliminates the risk of cross-linked channels due to delamination.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A beverage dispensing device, comprising:
a monolithic handle having a plurality of fluid inlet ports and a plurality of fluid outlet ports;
a plurality of valves situated within the handle, each valve movable in response to actuation;
a plurality of internal fluid channels integrally formed within the monolithic handle, each internal fluid channel possessing smooth walls without irregularities;
wherein a first internal fluid channel of the plurality of internal fluid channels fluidly couples a first fluid inlet port of the plurality of fluid inlet ports to a first valve of the plurality of valves; and
wherein a second internal fluid channel of the plurality of internal fluid channels fluidly couples the first valve to a first fluid outlet port of the plurality of fluid outlet ports.

2. The beverage dispensing device of claim 1 wherein a third internal fluid channel of the plurality of internal fluid channels fluidly couples a second fluid inlet port of the plurality of fluid inlet ports to a second valve of the plurality of valves, and wherein a fourth internal fluid channel of the plurality of internal fluid channels fluidly couples the second valve to a second fluid outlet port of the plurality of fluid outlet ports.

3. The beverage dispensing device of claim 2 wherein the first internal fluid channel contains a carbonated fluid.

4. The beverage dispensing device of claim 3 wherein the second internal fluid channel contains the carbonated fluid.

5. The beverage dispensing device of claim 4 wherein the first internal fluid channel includes a first turn of at least 30 degrees.

6. The beverage dispensing device of claim 5 wherein the second internal fluid channel includes a second turn of at least 30 degrees.

7. The beverage dispensing device of claim 6 wherein the first internal fluid channel has a cross-sectional area that is substantially circular in shape from the first fluid inlet port to the first valve.

8. The beverage dispensing device of claim 7 wherein the second internal fluid channel has a cross-sectional area that is substantially circular in shape from the first valve to the first fluid outlet port.

9. The beverage dispensing device of claim 8 wherein the third internal fluid channel contains a non-carbonated fluid.

10. The beverage dispensing device of claim 9 wherein the fourth internal fluid channel contains the non-carbonated fluid.

11. The beverage dispensing device of claim 10 wherein the monolithic handle is formed of medical grade nylon powder.
